(19) United States
(12) Patent Application Publication
(10) Pub. No.: US 2025/0079737 A1
(43) Pub. Date: Mar. 6, 2025

(54) Electrical Connector Cable Assembly

(71) Applicant: HARUMOTO TECHNOLOGY (SHEN ZHEN) CO., LTD., Shenzhen (CN)

(72) Inventors: CHING-CHUAN KUNG, Taipei (TW); YU-XUAN WU, Nantou (TW)

(21) Appl. No.: 18/809,640

(22) Filed: Aug. 20, 2024

(30) Foreign Application Priority Data
Sep. 5, 2023 (TW) 112133724

(51) Int. Cl. H01R 12/77; H01R 13/6594; H01R 13/66

(52) U.S. Cl. CPC H01R 12/775; H01R 12/774; H01R 13/6594; H01R 13/6658

(57) ABSTRACT

An electrical connector cable assembly, consisting of a ribbon cable joined with an electrical connector, and equipped with a fixing shielding base. The fixing shielding base can provide the fixation to the ribbon cable and the electrical connector to prevent disconnection of the ribbon cable and the electrical connector, and provides EMI shielding at the joining part of the electrical connector and the ribbon cable to address electromagnetic interference issues.

### CROSS-REFERENCE TO RELATED APPLICATIONS

This application claims the priority of Republic of China Patent Application No. 112133724 filed on Sep. 5, 2023, in the State Intellectual Property Office of the R.O.C., the disclosure of which is incorporated herein by reference.

### BACKGROUND OF THE INVENTION

### Field of the Invention

This application relates to an electrical connector cable assembly used for transmitting electrical signals. More specifically, it pertains to an electrical connector cable assembly designed to address electromagnetic interference issues and is used for transmitting high-speed or high-frequency signals.

### Descriptions of the Related Art

Electrical connector cable assemblies are frequently installed in various modern electronic devices to extend the transmission of electrical signals by connecting multiple electrical connector cable assemblies together within the electrical device. Currently, the structures of electrical connector cable assemblies can be generally divided into three types.

The first type of electrical connector cable assembly structure consists of an FPC (Flexible Printed Circuit) connected with an electrical connector. This type is often limited by the layering and wiring of the FPC, making it difficult to achieve high-frequency signal transmission. Typically, it can only transmit signals at frequencies below 10 GHz, and the signal loss during FPC transmission is relatively high. Therefore, this type cannot provide long-distance transmission for high-frequency or high-speed signals.

The second type of electrical connector cable assembly structure consists of a ribbon cable equipped with a circuit board and an electrical connector. In this type, the ribbon cable and the electrical connector are connected with the circuit board separately, and the circuit board is electrically connected with the ribbon cable and the electrical connector for signal transmission. This type usually comprises additional fixing components to secure the circuit board, the ribbon cable, and the electrical connector to prevent disconnection. Generally, the fixing components are made of a metal or insulated outer shell that covers the joining part of the ribbon cable, the electrical connector, and the circuit board. This adds bulk to the assembly, requiring more space in the electronic device.

The third type of electrical connector cable assembly comprises the ribbon cable and the electrical connector without the circuit board, wherein the ribbon cable is joined to the terminals equipped on the electrical connector. However, when the ribbon cable is joined with the electrical connector, there are electromagnetic interference (EMI) issues during high-speed or high-frequency signal transmission. To address this, in addition to adding fixing components to prevent the ribbon cable and the electrical connector from disconnecting, this type of electrical connector cable assembly structure usually requires additional shielding components to provide shielding during high-speed or high-frequency signal transmission when the ribbon cable is connected with the electrical connector to resolve the problem of electromagnetic interference during signal transmission. Typically, shielding components consist of a metal outer shell that covers the joining part of the ribbon cable and the electrical connector, as a result, enabling the size of the part of which the electrical connector cable assembly adds shielding components to be bigger, requiring more space within the electronic device.

Therefore, how to prevent disconnection between the ribbon cable and the electrical connector without adding extra fixing components, and how to solve the electromagnetic interference problem without adding extra shielding components, have become critical technical challenges in the industry today.

### SUMMARY OF THE INVENTION

In view of the drawbacks of the prior art mentioned above, the present application provides an electrical connector cable assembly, comprising: an electrical connector, comprising a signal terminal and a ground terminal; a ribbon cable, comprising a signal circuit and a ground circuit; and a fixing shielding base, comprising a ground conductive supporter, a ground conductive film, and a cable routing channel, wherein the ground terminal is joined with the ground conductive supporter, enabling the ground conductive supporter to provide support and fixation to the electrical connector, and the ground conductive supporter is connected with the ground conductive film, with the cable routing channel located between the supporter and the film, and the ribbon cable passes through the cable routing channel, allowing the fixing shielding base to provide the fixation to the ribbon cable, ensuring that the signal circuit can be joined with the signal terminal, and allow the ground circuit to be joined with the fixing shielding base, allowing the ground circuit, the ground terminal, the ground conductive supporter, and the ground conductive film to be electrically connected with each other to form an ground circuit, and the ground circuit allows the fixing shielding base to provide EMI shielding to the joining part of the electrical connector and the ribbon cable.

Preferably, the electrical connector cable assembly said above, further comprising: an insulation protective film, attached to the fixing shielding base to provide insulation protection for the ground circuit.

Preferably, the electrical connector cable assembly said above, wherein the ground conductive supporter comprises a supporter cable guiding structure and a supporter hollow structure, and the hollow part of the supporter hollow structure aligns with the signal terminal, and the supporter cable guiding structure is placed within the cable routing channel, guiding the ribbon cable through the channel, allowing the signal circuit to bypass the ground conductive supporter via the hollow part of the supporter hollow structure and be joined with the signal terminal, enabling the ground circuit to be joined with the ground conductive supporter.

Preferably, the electrical connector cable assembly said above, wherein the ground conductive supporter is either a metal conductive supporter or a non-metallic supporter with a conductive layer.

Furthermore, the present application also provides an electrical connector cable assembly, comprising: a circuit board, comprising a signal terminal joining structure, a ground terminal joining structure, a signal circuit joining structure, and a ground conductive supporter joining structure, wherein the signal terminal joining structure is electrically connected with the signal circuit joining structure, and the ground terminal joining structure is electrically connected with the ground conductive supporter joining structure; an electrical connector, comprising a signal terminal and a ground terminal, the signal terminal is joined with the signal terminal joining structure, and the ground terminal is joined with the ground terminal joining structure; a ribbon cable, comprising a signal circuit and a ground circuit; and a fixing shielding base, comprising a ground conductive supporter and a cable routing channel, wherein the ground conductive supporter comprises a supporter hollow structure, and the hollow part of the supporter hollow structure aligns with the signal circuit joining structure, and the ground conductive supporter is joined with the ground conductive supporter joining structure, allowing the ground conductive supporter to provide support and fixation to the electrical connector through the circuit board, and the ribbon cable passes through the cable routing channel, allowing the fixing shielding base to provide the fixation to the ribbon cable, allowing the signal circuit to bypass the ground conductive supporter via the hollow part of the supporter hollow structure to be joined with the signal circuit joining structure, enabling the signal circuit to electrically connect the signal terminal through the circuit board, allowing the ground circuit to be joined with the ground conductive supporter, enabling the ground circuit to electrically connect the ground terminal through the ground conductive supporter and the circuit board, providing EMI shielding for the electrical connector.

Preferably, the electrical connector cable assembly said above, further comprising: an insulation protective film, attached to the circuit board to provide insulation protection for the ground circuit.

Preferably, the electrical connector cable assembly said above, wherein the ground conductive supporter joining structure is the joining surface bypassing the signal circuit joining structure, allowing the ground conductive supporter to join the ground conductive supporter joining structure through surface contact.

In comparison to prior art, the electrical connector cable assembly provided in this application, consisting of a ribbon cable joined with an electrical connector, and equipped with a fixing shielding base. The fixing shielding base can provide the fixation to the ribbon cable and the electrical connector to prevent disconnection of the ribbon cable and the electrical connector, and provides EMI shielding at the joining part of the electrical connector and the ribbon cable to address electromagnetic interference issues.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1 to 2 are three-dimensional schematic diagrams of the fixing shielding base of the first embodiment of the electrical connector cable assembly of this application.

FIGS. 3 to 15 are schematic diagrams illustrating the component relationships of the first embodiment of the electrical connector cable assembly of this application.

FIGS. 16 to 17 are perspective schematic diagrams of the circuit board of the second embodiment of the electrical connector cable assembly of this application.

FIGS. 18 to 28 are schematic diagrams illustrating the component relationships of the second embodiment of the electrical connector cable assembly of this application.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

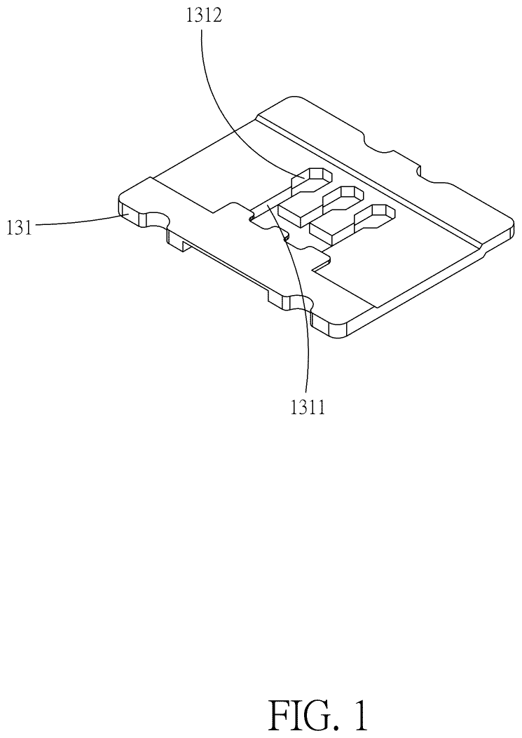

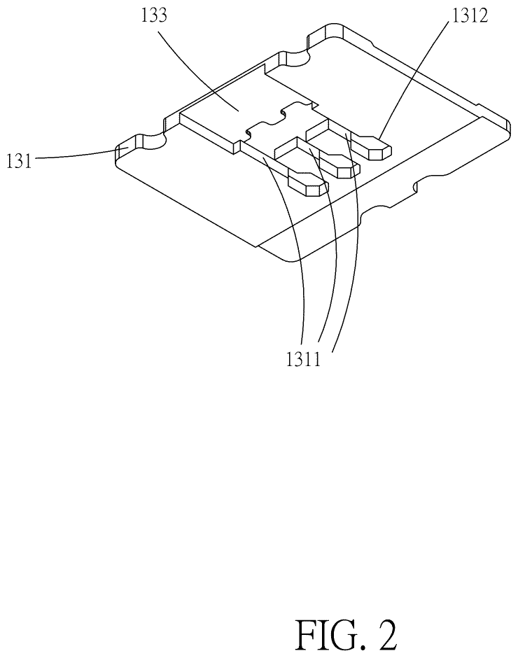

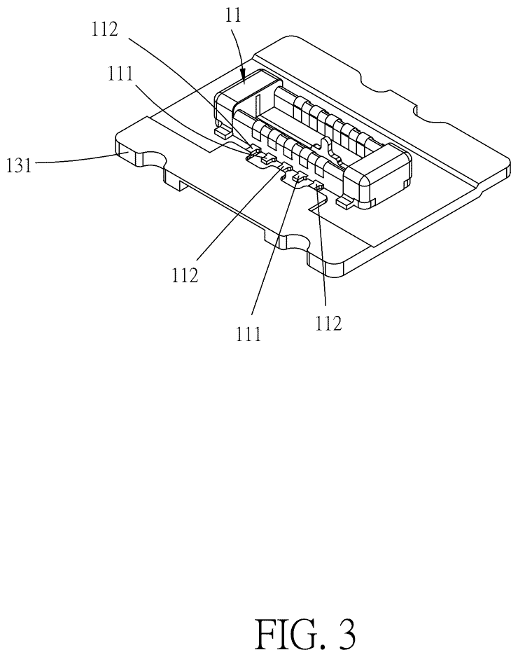

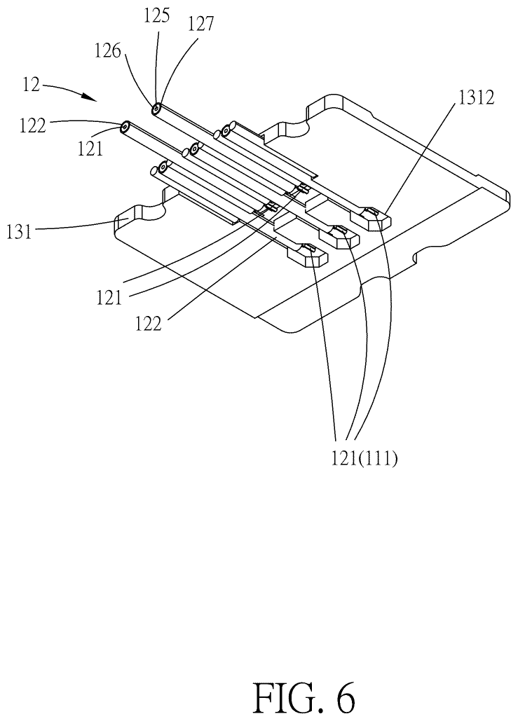

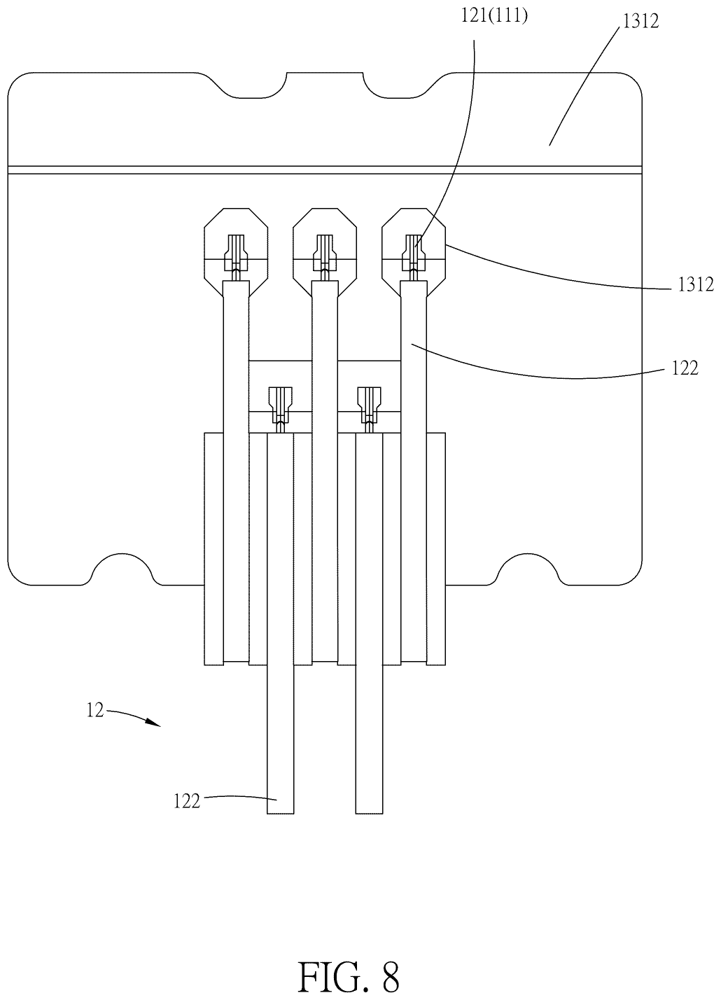

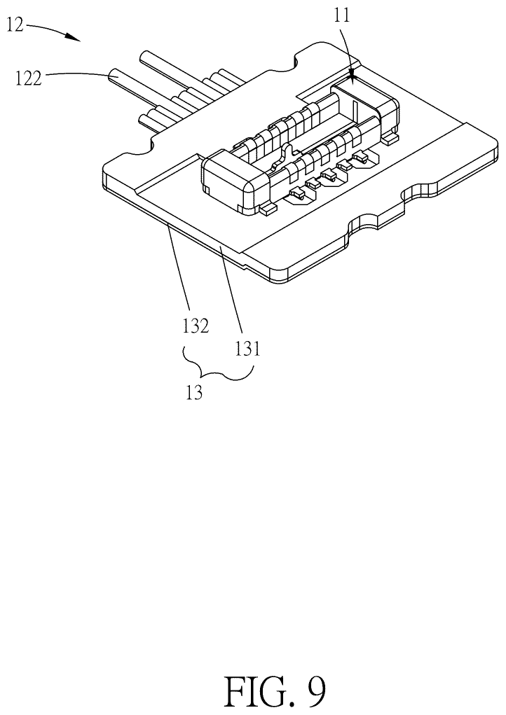

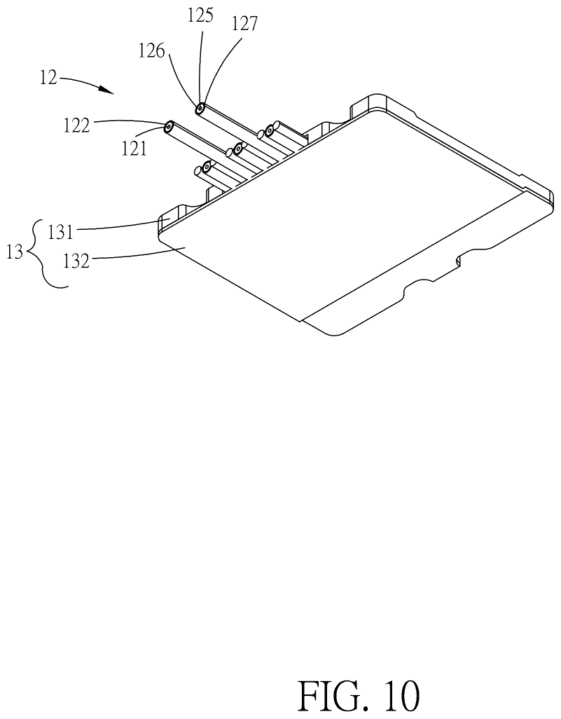

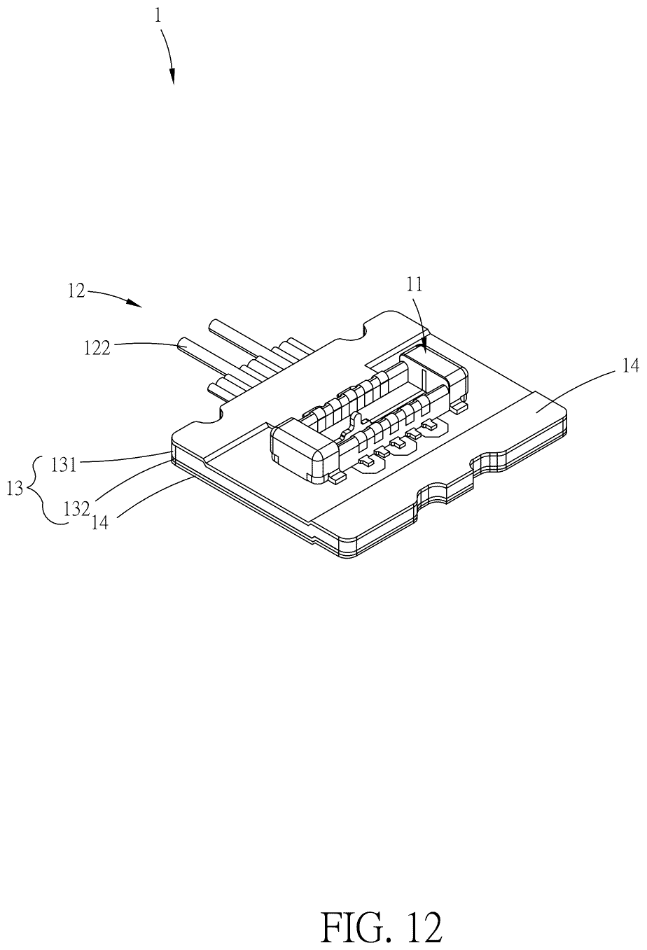

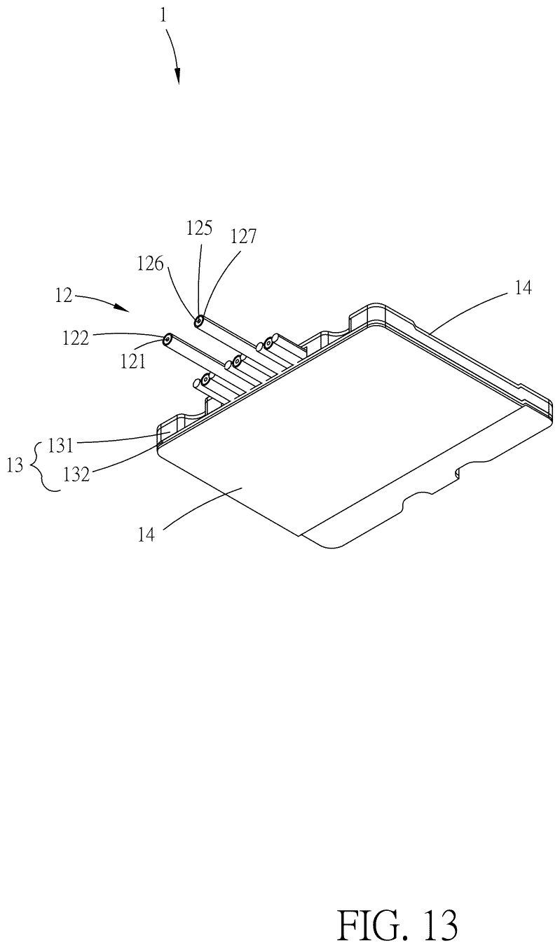

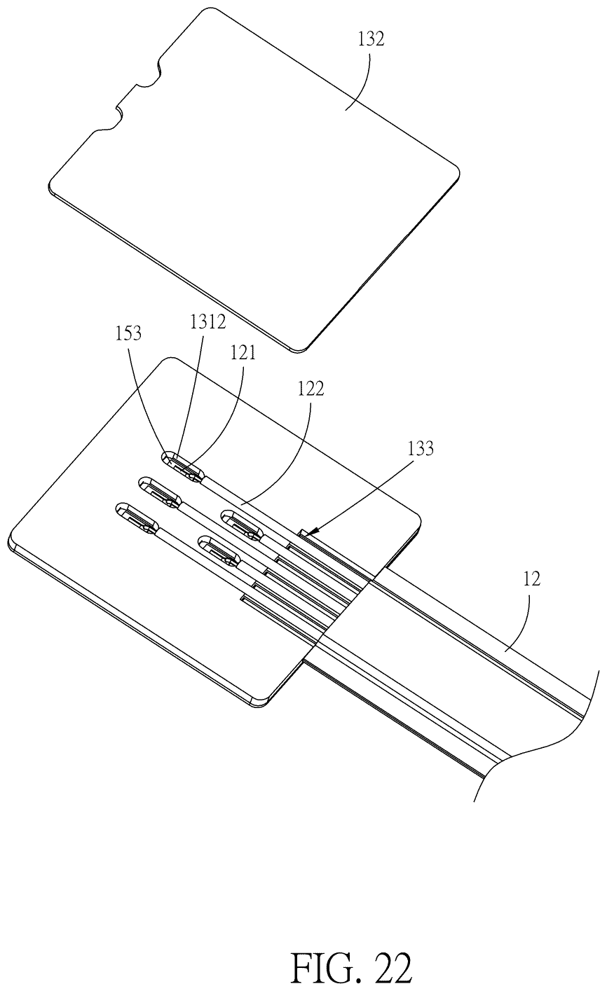

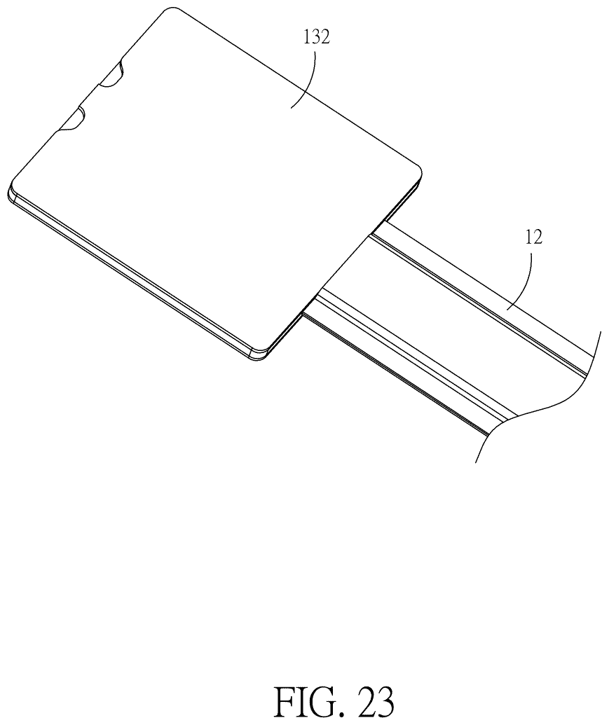

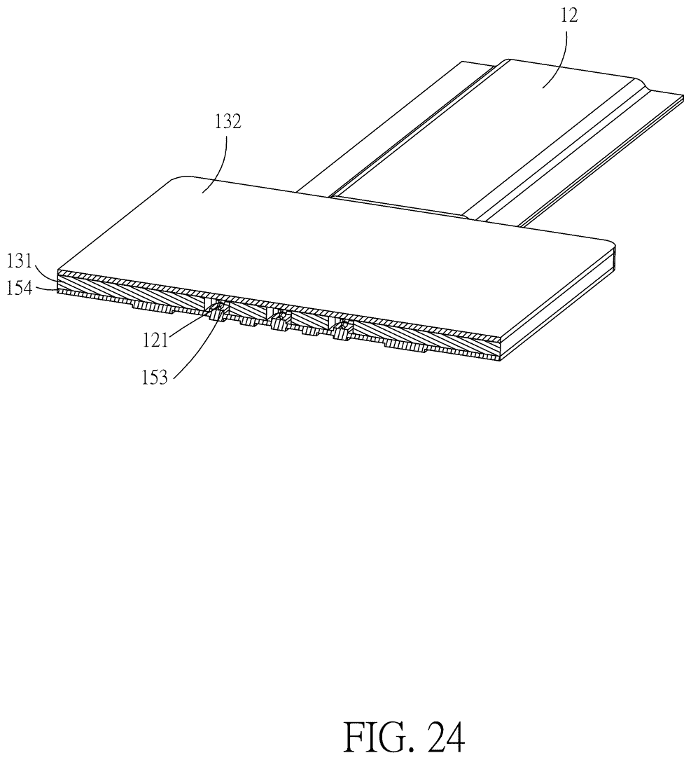

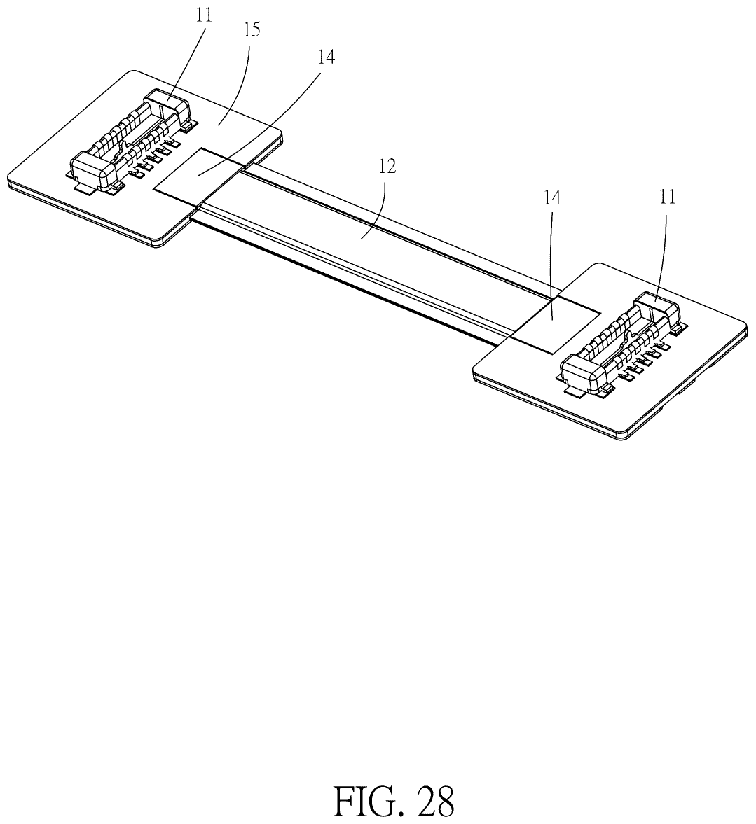

For a detailed description of the embodiments disclosed in the present application, please refer to FIGS. 1 to 28.

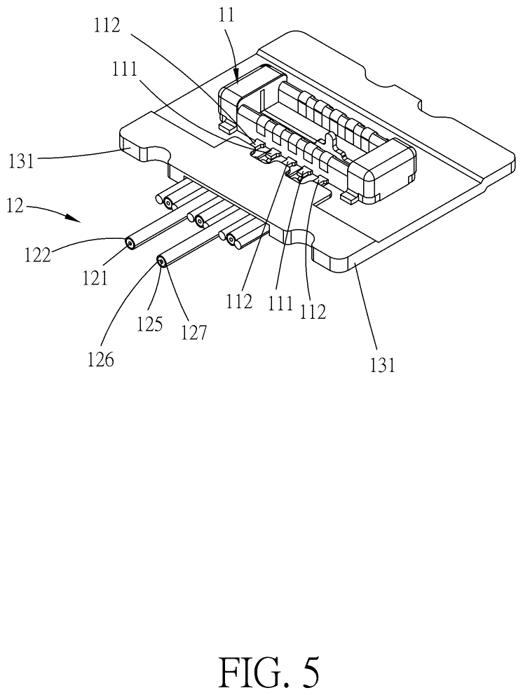

In the embodiments shown in FIGS. 1 to 15, an electrical connector cable assembly 1 is disclosed comprises: an electrical connector 11, a ribbon cable 12, a fixing shielding base 13, and an insulation protective film 14. The electrical connector 11 comprises a signal terminal 111 and a ground terminal 112. The ribbon cable 12 comprises a signal circuit 121 and a ground circuit 122. Optionally, the ribbon cable 12 can be configured as a coaxial cable structure with three layers, omitting an external insulation layer. Thus, as shown in FIGS. 5 to 6 and 10 to 11, the ribbon cable 12 comprises an inner conductor layer 125, an inner insulation layer 126, and an outer conductor layer 127.

It should be noted that if the ribbon cable 12 is configured as a coaxial cable omitting the external insulation layer, the thickness of the ribbon cable 12 can be effectively reduced, allowing it to be used in height-restricted spaces.

In the above embodiment, the inner insulation layer 126 separates the inner conductor layer 125 from the outer conductor layer 127. The signal circuit 121 is located in the inner conductor layer 125 and can transmit high-frequency or high-speed signals. The ground circuit 122 is located in the outer conductor layer 127 and can transmit shielding signals, such as ground signals. The inner insulation layer 126 encases the inner conductor layer 125, providing impedance matching for the signal transmission of the inner conductor layer 125. The outer conductor layer 127 encases the inner insulation layer 126, serving as a metal shielding layer to provide the shield to prevent the signal transmitted by the inner conductor layer 125 from being affected by electromagnetic interference (EMI), leakage loss, or becoming a source of noise interference in signal transmission. This configuration allows the ribbon cable 12 to transmit high-frequency or high-speed signals over long distances. Optionally, the outer conductor layer 127 can be a single-layer or multi-layer conductor structure made of at least one of braided metal, wrapped metal, or wound metal.

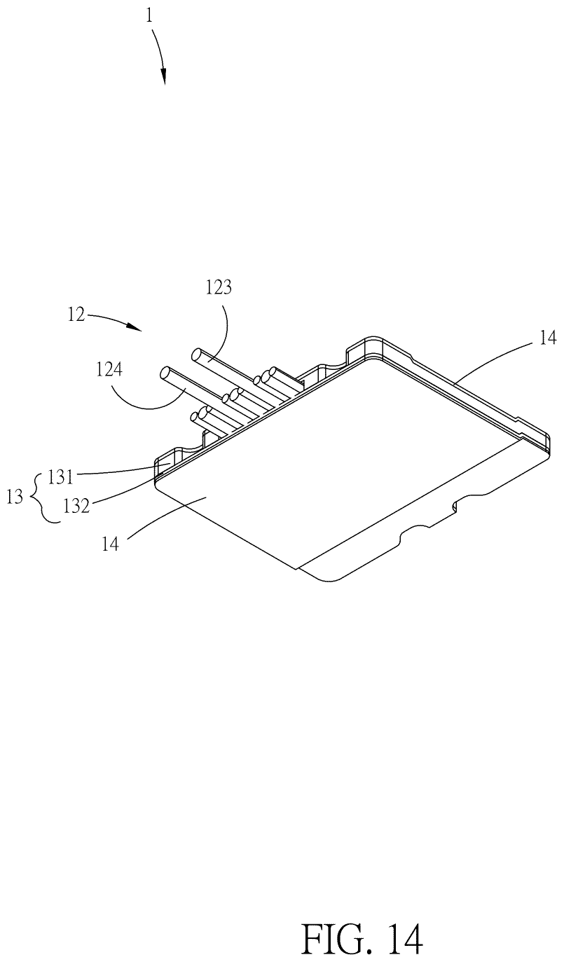

However, the above is not limiting. The ribbon cable 12 can alternatively use metal cables or electronic cables capable of transmitting signals. As shown in FIG. 14, the ribbon cable 12 consists of a separate signal cable 123 and a ground cable 124. Accordingly, the signal circuit 121 is located in the signal cable 123, and the ground circuit 122 is located in the ground cable 124.

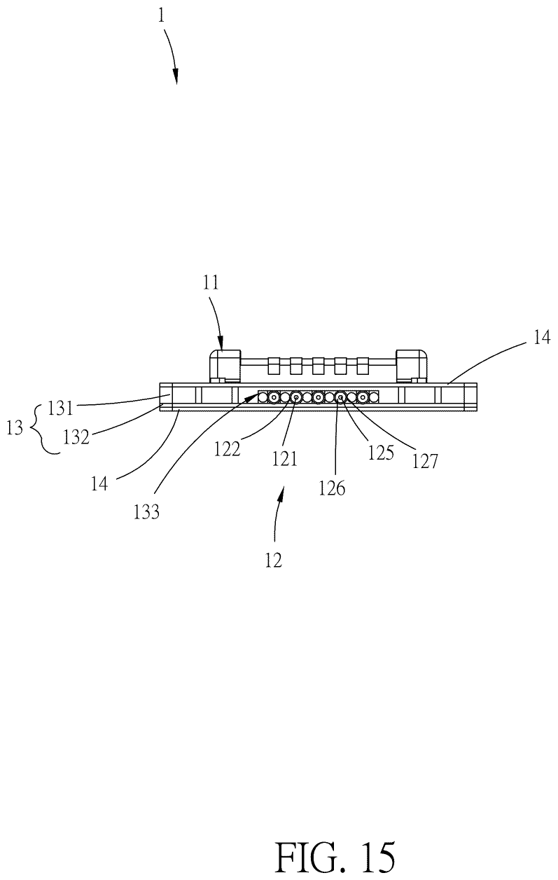

As shown in FIG. 15, the fixing shielding base 13 comprises a ground conductive supporter 131, a ground conductive film 132, and a cable routing channel 133. The ground conductive supporter 131 is made of a metal material conductive supporter or a non-metallic material supporter with a conductive layer. It should be noted that the conductive layer can be formed on the non-metallic material supporter by plating it with a conductive material.

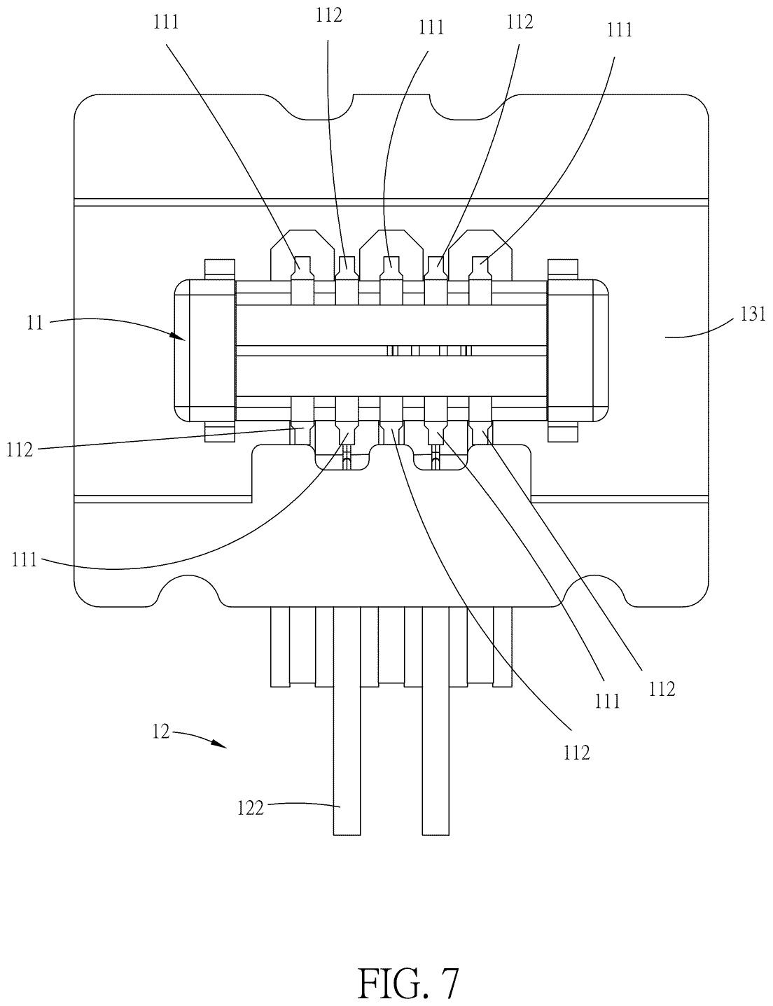

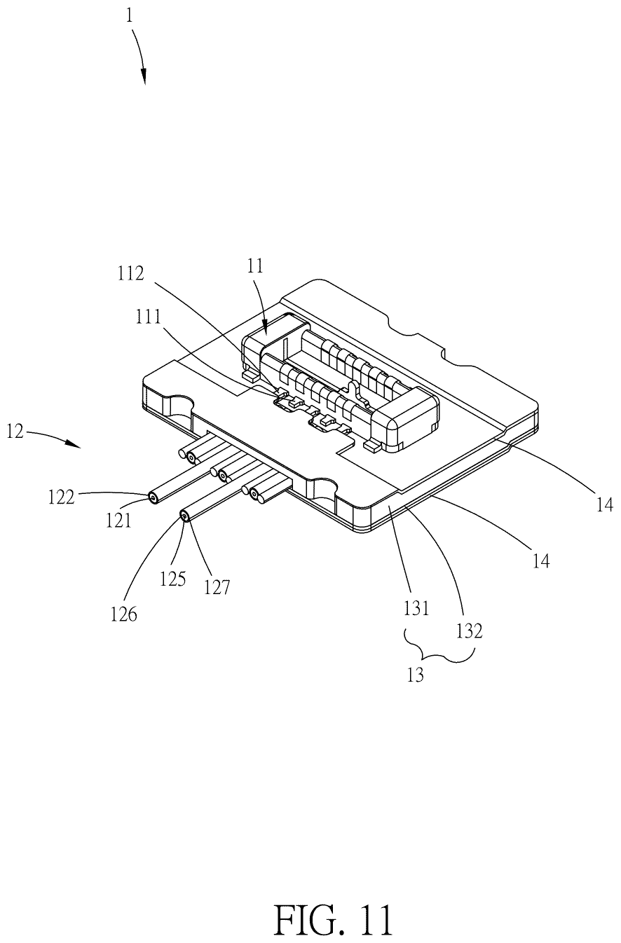

In the aforementioned embodiment, as shown in FIG. 7, the ground terminal 112 is joined with the ground conductive supporter 131, allowing the ground conductive supporter 131 provides support and fixation for the electrical connector 11, preventing the electrical connector 11 from detaching from the electrical connector cable assembly 1. As shown in FIG. 11, the ground conductive supporter 131 is joined with the ground conductive film 132, allowing the ground conductive supporter 131 to be electrically connected with the ground conductive film 132 to be able to transmit shielding signals, such as ground signals.

As shown in FIG. 15, the cable routing channel 133 is positioned between the ground conductive supporter 131 and the ground conductive film 132. The ribbon cable 12 can be routed through the cable routing channel 133, allowing the fixing shielding base 13 to secure the ribbon cable 12 and prevent the ribbon cable 12 from detaching from the electrical connector cable assembly 1, enabling the signal circuit 121 to be joined with the signal terminal 111, and the ground circuit 122 to be joined with the fixing shielding base 13, ensuring the ground terminal 112, the ground circuit 122, the ground conductive supporter 131, and the ground conductive film 132 are electrically connected with form a ground circuit. Through the ground circuit, the fixing shielding base 13 provides EMI shielding at the joining part between the electrical connector 11 and the ribbon cable 12, consequently, preventing the electrical connector cable assembly 1 from the electromagnetic interference at the joining part of the electrical connector 11 and the ribbon cable 12, making the electrical connector cable assembly 1 suitable for high-frequency or high-speed signal transmission applications.

It should be noted that, in the aforementioned embodiment, the signal circuit 121 can be joined with the signal terminal 111 using various joining methods such as soldering, hot pressing welding, laser welding, or resistance welding. Furthermore, the ground circuit 122 can be joined with the fixing shielding base 13 various joining methods such as soldering, hot pressing welding, laser welding, or resistance welding.

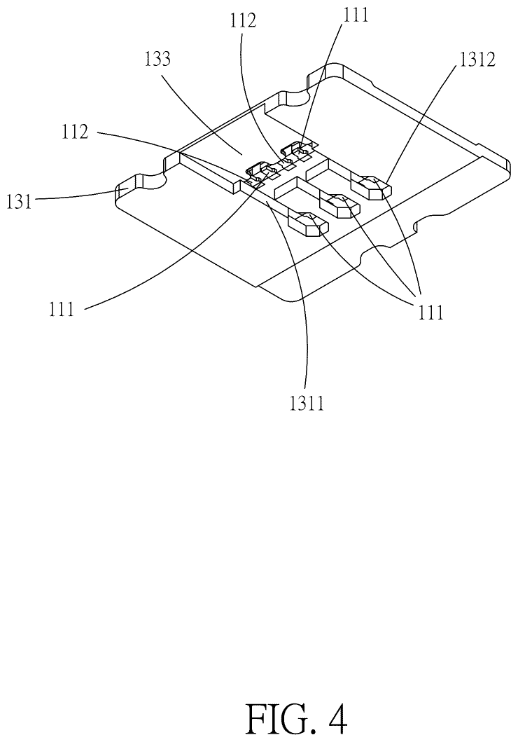

Optionally, as shown in FIGS. 4 to 6, the ground conductive supporter 131 comprises a supporter cable guiding structure 1311 and a supporter hollow structure 1312. The hollow part of the supporter hollow structure 1312 aligns with the signal terminal 111. The supporter cable guiding structure 1311 is a guiding structure set in the cable routing channel 133, directing the ribbon cable 12 through the cable routing channel 133 for placement and assembly of the ribbon cable 12, allowing the signal circuit 121 to bypass the fixing shielding base 13 (or the ground conductive supporter 131) through the hollow part of the supporter hollow structure 1312 and be joined (be electrically connected) with the signal terminal 111 at a predetermined position. Similarly, the ground circuit 122 can be joined (be electrically connected) with the fixing shielding base 13 (or the ground conductive supporter 131) at a predetermined position.

As shown in FIG. 14, the insulation protective film 14 is attached to the fixing shielding base 13, providing insulation protection for the grounding circuit to prevent short circuits caused by the fixing shielding base 13 coming into electrical contact with other conductive materials during use. It should be noted that the insulation protective film 14 can be selected as an adhesive film, hot adhesive film, or thermal lamination film. Optionally, as shown in FIG. 15, the insulation protective film 14 is attached to the surfaces of the ground conductive supporter 131 and the ground conductive film 132.

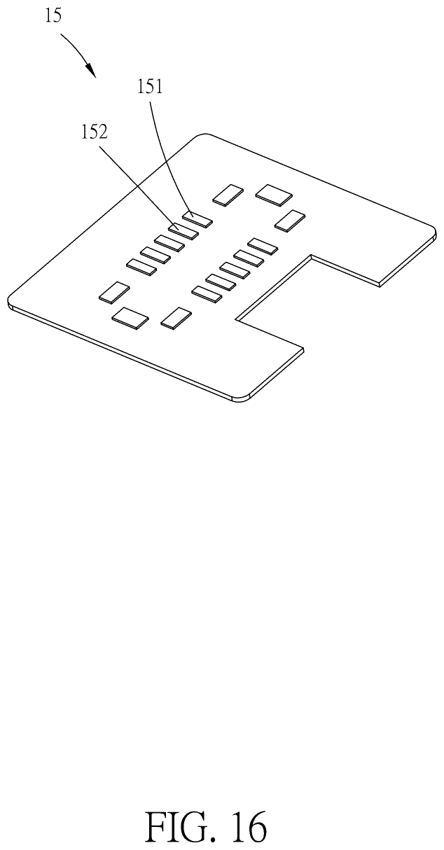

In the embodiment shown in FIGS. 16 to 28, an electrical connector cable assembly 1 is disclosed. The electrical connector cable assembly 1 comprises: an electrical connector 11, a ribbon cable 12, a fixing shielding base 13, an insulation protective film 14, and a circuit board 15. The electrical connector 11 comprises a signal terminal 111 and a ground terminal 112. The ribbon cable 12 comprises a signal circuit 121 and a ground circuit 122.

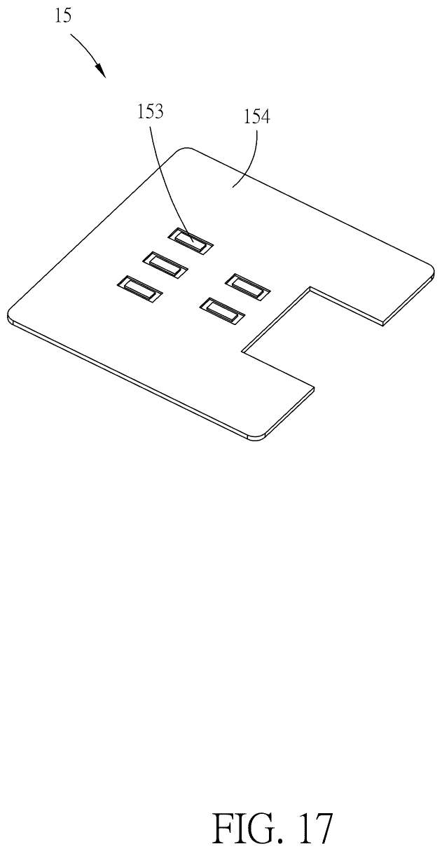

As shown in FIGS. 16 and 17, the circuit board 15 comprises a signal terminal joining structure 151, a ground terminal joining structure 152, a signal circuit joining structure 153, and a ground conductive supporter joining structure 154. It should be noted that the circuit board 15 comprises a circuit structure, allowing the signal terminal joining structure 151 to be electrically connected with the signal circuit joining structure 153, and the ground terminal joining structure 152 to be electrically connected with the ground conductive supporter joining structure 154.

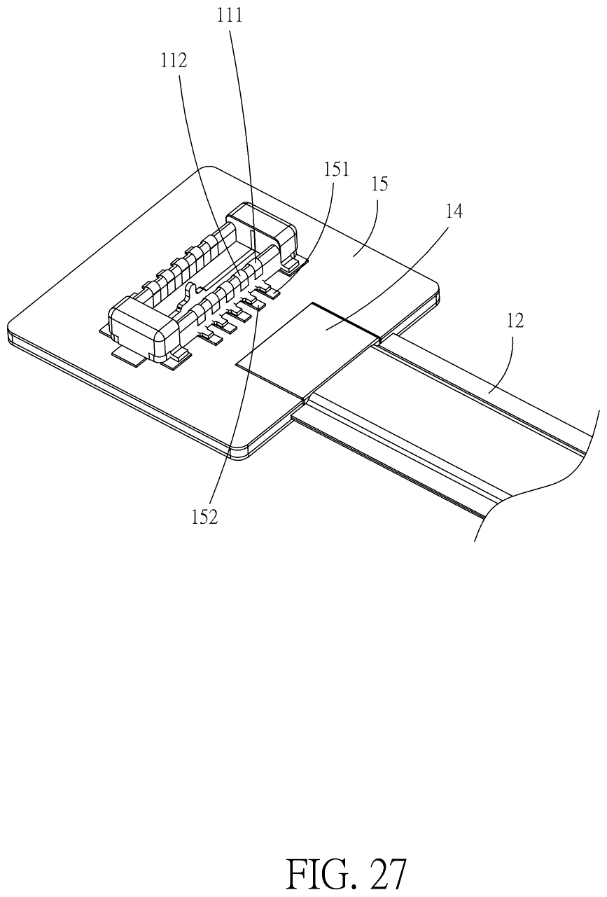

As shown in FIG. 27, the electrical connector 11 comprises a signal terminal 111 and a ground terminal 112. It should be noted that the signal terminal 111 is joined with the signal terminal joining structure 151, and the ground terminal 112 is joined with the ground terminal joining structure 152.

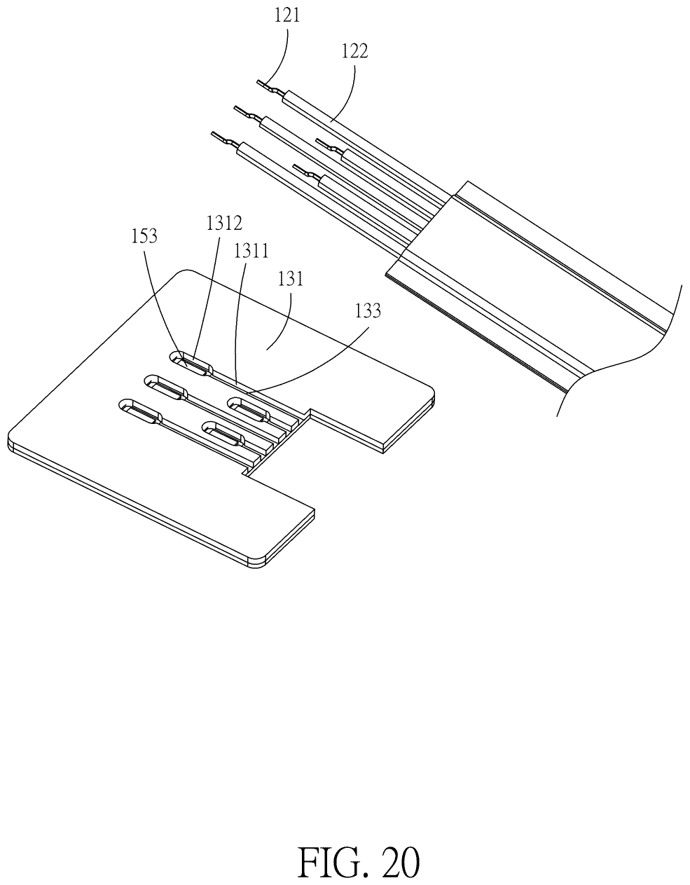

As shown in FIG. 20, the fixing shielding base 13 comprises a ground conductive supporter 131 and a cable routing channel 133. The ground conductive supporter 131 comprises a supporter hollow structure 1312.

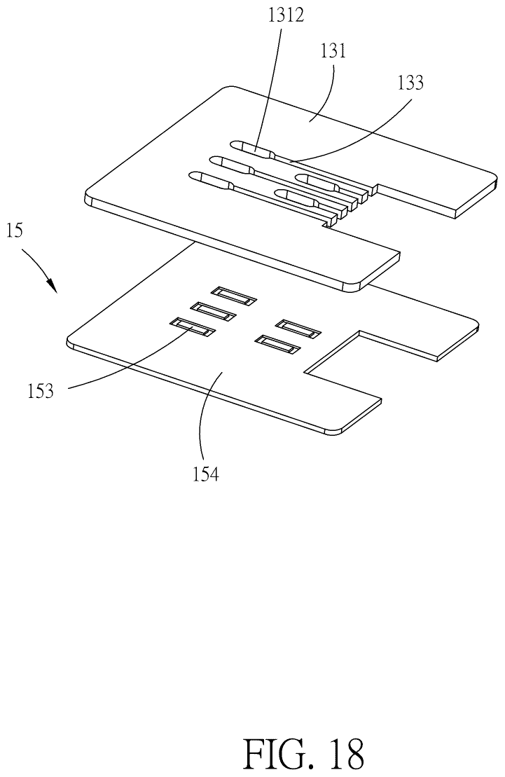

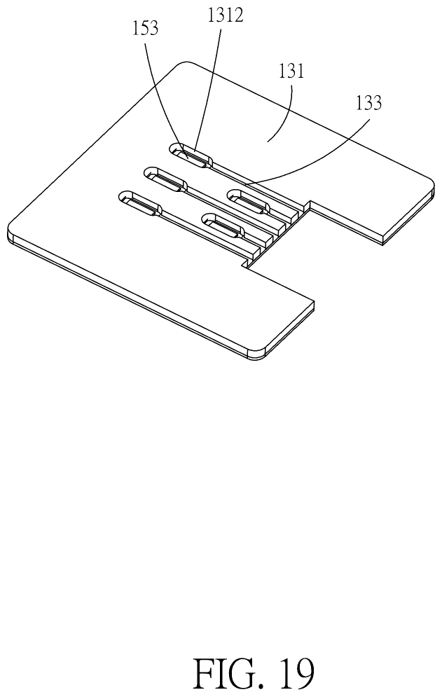

In the above embodiments, as shown in FIGS. 18 to 19, the ground conductive supporter 131 is joined with the ground conductive supporter joining structure 154, allowing the ground conductive supporter 131 to provide support and fixation to the electrical connector 11 through the circuit board 15, preventing the electrical connector 11 from disconnecting from the electrical connector cable assembly 1. Additionally, the hollow portion of the supporter hollow structure 1312 is aligned with the signal circuit joining structure 153 to prevent the signal circuit joining structure 153 from being joined (being electrically connected) with the ground conductive supporter 131.

As shown in FIGS. 20 to 22, the ribbon cable 12 can pass through the cable routing channel 133, allowing the fixing shielding base 13 to secure the ribbon cable 12 to prevent the ribbon cable 12 from disconnecting from the electrical connector cable assembly 1, enabling the signal circuit 121 to be able to pass through the hollow apart of the supporter hollow structure 1312, avoiding the ground conductive supporter 131, and be joined with the signal circuit joining structure 153. This allows the signal circuit 121 to be electrically connected with the signal terminal 111 via the circuit board 15. Furthermore, the ground circuit 122 can be joined with the ground conductive supporter 131, allowing the ground circuit 122 to be electrically connected with the ground terminal 112 via the ground conductive supporter 131 and the circuit board 15, transmitting shielding signals such as ground signals to provide EMI shielding for the electrical connector 11. Thus, it prevents electromagnetic interference at the joining part between the electrical connector cable assembly 1 and the ribbon cable 12, facilitating applications of the electrical connector cable assembly 1 in high-frequency or high-speed signal transmissions.

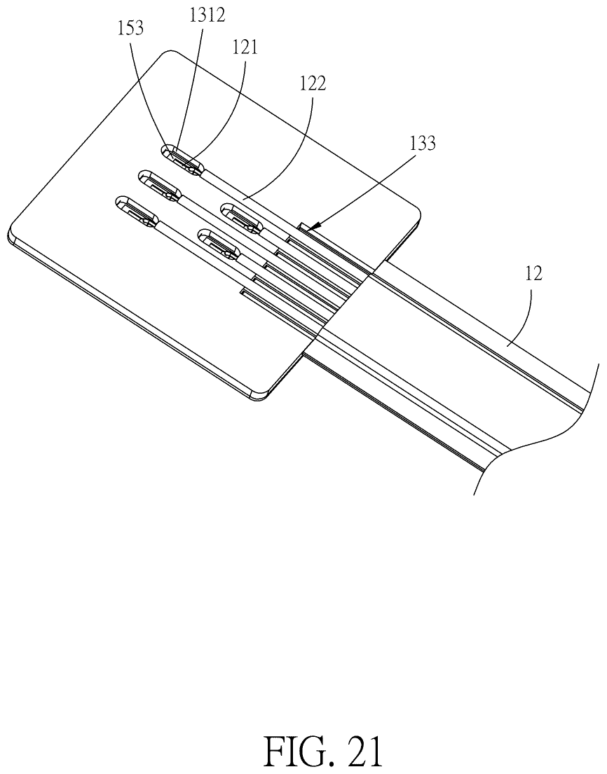

Optionally, as shown in FIGS. 20 to 21, the ground conductive supporter 131 comprises a supporter cable guiding structure 1311, and the supporter cable guiding structure 1311 is the guiding structure positioned within the cable routing channel 133 to guide the ribbon cable 12 through the cable routing channel 133, facilitating the placement and assembly of the ribbon cable 12, allowing the signal circuit 121 to be joined with the signal circuit joining structure 153 at a predetermined position, and enables the ground circuit 122 to be joined with the ground conductive supporter 131 at a predetermined position.

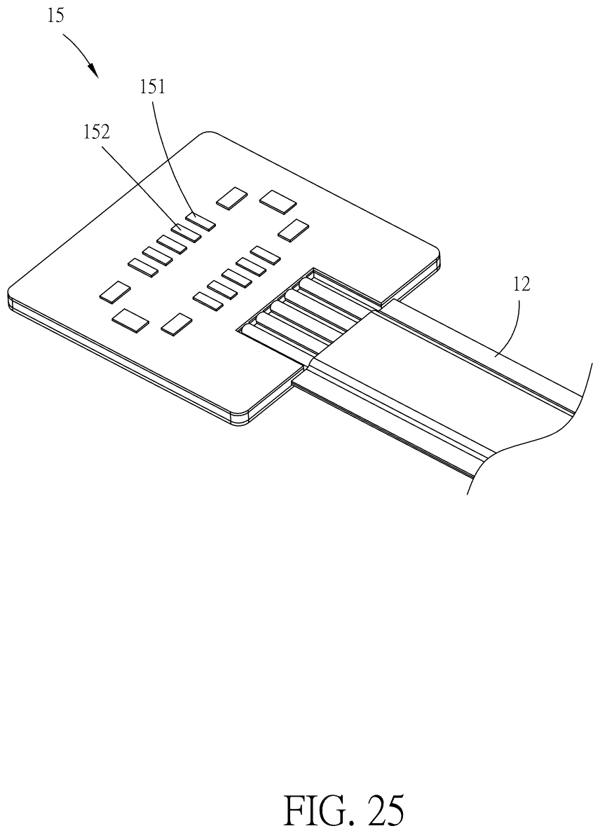

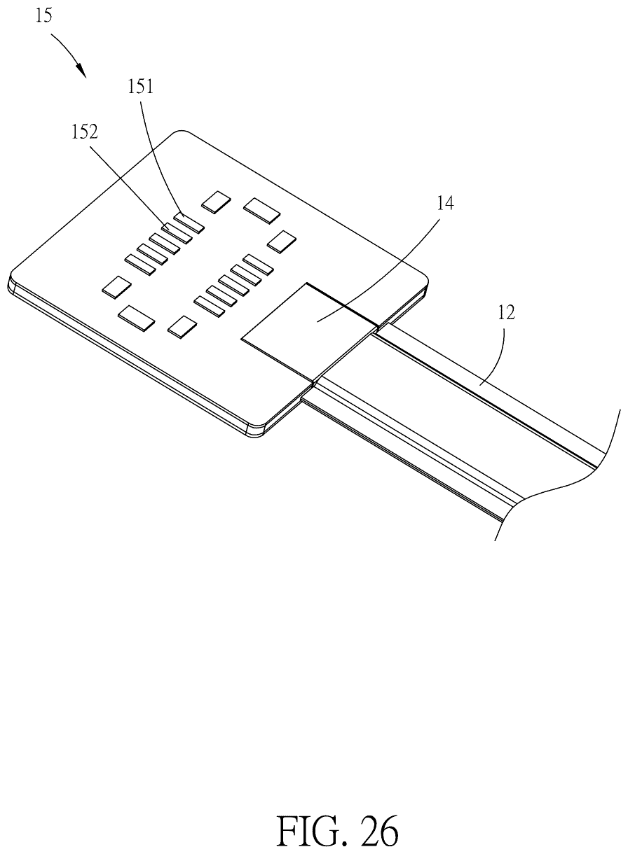

As shown in FIGS. 25 to 26, the insulation protective film 14 is attached to the circuit board 15 to provide insulation protection for the ground circuit 122, preventing the ground circuit 122 from coming into electrical contact with other conductors and causing a short circuit. It should be noted that the insulation protective film 14 may optionally be made of adhesive film, hot adhesive film, or thermal lamination film.

It should be noted that the electrical connector cable assembly of the present application may omit certain components, not limited to the embodiments described above.

For example, the electrical connector cable assembly of the present application may optionally include only: an electrical connector, a ribbon cable, and a fixing shielding base. The electrical connector comprises a signal terminal and a ground terminal. The ribbon cable comprises a signal circuit and a ground circuit. The fixing shielding base comprises a ground conductive supporter, a ground conductive film, and a cable routing channel. The ground terminal is joined with the ground conductive supporter, allowing ground conductive supporter to provide support and fixation to the electrical connector via the circuit board. The ground conductive supporter is connected with the ground conductive film, and the cable routing channel is located between the ground conductive supporter and the ground conductive film. The ribbon cable can pass through the cable routing channel, allowing the fixing shielding base to provide fixation for the ribbon cable, enabling the signal circuits to be joined with the signal terminals and the ground circuits to be joined with the fixing shielding base, forming an electrical connection between the ground terminals, the ground circuits, the ground conductive supporter, and the ground conductive film to provide EMI shielding for the joining part between the electrical connector and the ribbon cable.

Additionally, the electrical connector cable assembly of the present application may optionally include only: a circuit board, an electrical connector, a ribbon cable, and a fixing shielding base. The circuit board comprises a signal terminal joining structure, a ground terminal joining structure, a signal circuit joining structure, and a ground conductive supporter joining structure. The signal terminal joining structure and signal circuit joining structure are electrically connected, and the ground terminal joining structure and ground conductive supporter joining structure are electrically connected. The electrical connector comprises signal terminals joined with the signal terminal joining structure and ground terminals joined with the ground terminal joining structure. The ribbon cable comprises signal circuits and ground circuits. The fixing shielding base comprises a ground conductive supporter and a cable routing channel. The ground conductive supporter comprises a supporter hollow structure, with its hollow portion aligned with the signal circuit joining structure, and is joined with the ground conductive supporter joining structure, allowing the ground conductive supporter to be supported and fixed to the electrical connector via the circuit board. The ribbon cable can pass through the cable routing channel, allowing the fixing shielding base to provide fixation for the ribbon cable. The signal circuits can avoid the ground conductive supporter and connect to the signal circuit joining structure via the hollow portion of the supporter hollow structure, enabling the signal circuits to be electrically connected with the signal terminals via the circuit board and allows the ground circuits to be connected with the ground conductive supporter, allowing the ground circuits to provide EMI shielding through the ground conductive supporter and the circuit board being electrically connected with the ground terminal.

In summary, an electrical connector cable assembly provided in this application, and the electrical connector cable assembly consisting of a ribbon cable joined with an electrical connector, and equipped with a fixing shielding base. The fixing shielding base can provide the fixation to the ribbon cable and the electrical connector to prevent disconnection of the ribbon cable and the electrical connector, and provides EMI shielding at the joining part of the electrical connector and the ribbon cable to address electromagnetic interference issues.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. An electrical connector cable assembly, comprising:
an electrical connector, comprising a signal terminal and a ground terminal;
a ribbon cable, comprising a signal circuit and a ground circuit; and
a fixing shielding base, comprising a ground conductive supporter, a ground conductive film, and a cable routing channel, wherein the ground terminal is joined with the ground conductive supporter, enabling the ground conductive supporter to provide support and fixation to the electrical connector, and the ground conductive supporter is connected with the ground conductive film, with the cable routing channel located between the supporter and the film, and the ribbon cable passes through the cable routing channel, allowing the fixing shielding base to provide the fixation to the ribbon cable, ensuring that the signal circuit can be joined with the signal terminal, and allow the ground circuit to be joined with the fixing shielding base, allowing the ground circuit, the ground terminal, the ground conductive supporter, and the ground conductive film to be electrically connected with each other to form an ground circuit, and the ground circuit allows the fixing shielding base to provide EMI shielding to the joining part of the electrical connector and the ribbon cable.

2. The electrical connector cable assembly of claim 1, wherein further comprising: an insulation protective film, attached to the fixing shielding base to provide insulation protection for the ground circuit.

3. The electrical connector cable assembly of claim 1, wherein the ground conductive supporter comprises a supporter cable guiding structure and a supporter hollow structure, and the hollow part of the supporter hollow structure aligns with the signal terminal, and the supporter cable guiding structure is placed within the cable routing channel, guiding the ribbon cable through the channel, allowing the signal circuit to bypass the ground conductive supporter via the hollow part of the supporter hollow structure and be joined with the signal terminal, enabling the ground circuit to be joined with the ground conductive supporter.

4. The electrical connector cable assembly of claim 1, wherein the ground conductive supporter is either a metal conductive supporter or a non-metallic supporter with a conductive layer.

5. An electrical connector cable assembly, comprising:
a circuit board, comprising a signal terminal joining structure, a ground terminal joining structure, a signal circuit joining structure, and a ground conductive supporter joining structure, wherein the signal terminal joining structure is electrically connected with the signal circuit joining structure, and the ground terminal joining structure is electrically connected with the ground conductive supporter joining structure;
an electrical connector, comprising a signal terminal and a ground terminal, the signal terminal is joined with the signal terminal joining structure, and the ground terminal is joined with the ground terminal joining structure;
a ribbon cable, comprising a signal circuit and a ground circuit; and
a fixing shielding base, comprising a ground conductive supporter and a cable routing channel, wherein the ground conductive supporter comprises a supporter hollow structure, and the hollow part of the supporter hollow structure aligns with the signal circuit joining structure, and the ground conductive supporter is joined with the ground conductive supporter joining structure, allowing the ground conductive supporter to provide support and fixation to the electrical connector through the circuit board, and the ribbon cable passes through the cable routing channel, allowing the fixing shielding base to provide the fixation to the ribbon cable, allowing the signal circuit to bypass the ground conductive supporter via the hollow part of the supporter hollow structure to be joined with the signal circuit joining structure, enabling the signal circuit to electrically connect the signal terminal through the circuit board, allowing the ground circuit to be joined with the ground conductive supporter, enabling the ground circuit to electrically connect the ground terminal through the ground conductive supporter and the circuit board, providing EMI shielding for the electrical connector.

6. The electrical connector cable assembly of claim 5, wherein further comprising: an insulation protective film, attached to the circuit board to provide insulation protection for the ground circuit.

7. The electrical connector cable assembly of claim 5, wherein the ground conductive supporter joining structure is the joining surface bypassing the signal circuit joining structure, allowing the ground conductive supporter to join the ground conductive supporter joining structure through surface contact.
